(19) United States
(12) Patent Application Publication
(10) Pub. No.: US 2014/0047934 A1
(43) Pub. Date: Feb. 20, 2014

(54) METHOD OF SIMULATING OPERATIONS OF NON-DESTRUCTIVE TESTING UNDER REAL CONDITIONS USING SYNTHETIC SIGNALS

(71) Applicants: Nicolas Dominguez, Plaisnance Due Touch (FR); Didier Simonet, Leguevin (FR)

(72) Inventors: Nicolas Dominguez, Plaisnance Due Touch (FR); Didier Simonet, Leguevin (FR)

(73) Assignee: EUROPEAN AERONAUTIC DEFENCE AND SPACE COMPANY EADS FRANCE, PARIS (FR)

(21) Appl. No.: 14/112,062

(22) PCT Filed: Apr. 16, 2012
(86) PCT No.: PCT/EP2012/056909

§ 371 Date: Oct. 16, 2013

(30) Foreign Application Priority Data
Apr. 21, 2011 (FR) 1153486

(51) Int. Cl. G01M 99/00

(52) U.S. Cl. CPC G01M 99/008
USPC 73/866.4

(57) ABSTRACT

A method of simulating non-destructive testing with the aid of at least one probe. The method comprises the steps of measuring inspection parameters, in particular related to the position of the probe in space and generating synthetic signals corresponding to a non-destructive testing operation.

### FIELD OF THE INVENTION

This invention relates to a method of simulating non-destructive testing under real conditions using synthetic signals.

This invention uses operations of non-destructive testing. It is classified in the category of simulators, on the same principle as operations simulators, such as flight simulators or nuclear power plant control room simulators, but it is applied to operations of non-destructive testing.

### PRIOR ART

The prior art contains a first need related to estimating the Probability of Detection (POD) associated with an inspection procedure. The current approach, which is completely experimental, is a very expensive task (costing around [symbol] 200,000) that requires the manufacture of a large number of parts containing representative defects in order to establish a detection statistic by analyzing the results of inspections carried out by a set of inspectors.

Methodologies for establishing POD curves that use simulation data are being studied, but they still suffer from not factoring in human behavior, which may have a significant effect on the detection statistic (fatigue, access, reading the screen, interpretation/diagnostic, etc.).

A corollary need is that comprised of quantifying the detection performance of automatic diagnostic software.

The prior art contains a second need, related to the training of operators on the complicated operations of performing non-destructive testing on representative parts. The significant cost of aerospace parts and the difficulty of creating realistic defects and varying their characteristics (geometry and position) makes it difficult, if not impossible, to train operators under operating conditions. A simulator would therefore make is possible to train non-destructive testing (NDT) inspectors under realistic conditions and to submit them to a broad variety of operations incidents and defects. This could significantly improve the reliability of inspections and ensure that procedures are properly followed.

Finally, a last need is to test the validity and difficulty of implementing procedures along with their sensitivity to operating conditions, as well as to qualify them. This makes it possible, in a design office, to establish procedures under realistic conditions and to anticipate detection performance before going to the Probability of Detection (POD) establishment for a design case.

It is a challenge to improve the reliability of non-destructive testing (NDT) processes during the manufacturing and maintenance phases at acceptable costs.

There is a technique in the prior art for estimating Probability of Detection (POD) curves using an experimental approach.

The estimation of POD curves results for the statistical analysis of results of inspections on a set of representative defects in the structure targeted by the procedure.

The defects in the sample must be distributed over a range of sizes that covers the defect sizes that will be very rarely detected and the defect sizes that will very rarely be missed.

We get data that expresses the result of the inspection (quantitative or binary) based on the characteristic size of the defect (FIG. 1a). After statistical analysis, we get curves like the one in FIG. 1b.

The statistical representativity criteria requires having a large number of structure samples. The recommendations from MIL-HDBK-1823 (available at http://mh1823.com/mh1823/MIL-HDBK-1823A(2009).pdf) are for at least 60 structure elements containing defects, plus about 15 clean samples to test the false positive rate.

The prior also includes estimates of POD curves based on simulations.

Some research work conducted recently have made it possible to implement a methodology for using simulated data for the POD estimation.

The methodology consists of defining uncertainties on the parameters used as input for the simulation software for the testing operation (ex. CIVA) in order to simulate the variability on the inspection results (the outputs of the simulation).

The current solutions have the following limitations:
On one hand, the completely experimental approach is extremely expensive and limits the amount of data available in the statistic and/or the representativity of the samples used for the testing campaign (ex. use of cuts instead of panels mounted on the structure).
On the other hand, the completely simulated approach does not allow for the introduction of a realistic human behavior model, which despite the possibility of covering uncertainties, still leaves the question of the validity of the results and their applicability. Also, one of the main difficulties of this approach is defining the uncertainties in the input to the simulations in order to generate ad hoc variability in the output.

### DESCRIPTION OF THE INVENTION

This invention intends to remedy the disadvantages of the prior art by proposing a method of simulating non-destructive testing using synthetic signals.

To this effect, this invention concerns, in its more general sense, a method of simulating non-destructive testing using at least one probe, characterized in that it comprises the following steps:
a measurement for inspection parameters, linked to the position of said probe in the space; and
a generation of synthetic signals corresponding to an operation of non-destructive testing.

According to an embodiment, said generation of synthetic signals is partly conditioned by a configuration generated by a configuration generator that consists of a virtual structure model.

Preferably, said virtual model of the structure is completed by the introduction of defects and/or by the modification of the properties of the structure elements.

According to an embodiment, said synthetic signals are measured signals.

According to an embodiment, said synthetic signals are measured and modified signals.

Advantageously, said signals are modified according to a weighting, according to a time-based amplification, and/or according to a transfer function.

According to an embodiment, said synthetic signals are simulated and/or modeled.

According to an embodiment, said synthetic signals are a combination of:
measured and possibly modified signals; and
simulated and/or modeled signals.

According to one variant, said synthetic signals are measured on the concerned structure areas, taking into account information related to the real positioning of said probe in the space.

Advantageously, said synthetic signals are measured on the concerned structure areas, taking into account information related to the settings carried out by an operator.

According to an embodiment, the measurement of the inspection parameters related to the position of said probe in the space is carried out by means of a simple encoding.

According to an embodiment, the measurement of the inspection parameters related to the position of said probe in the space is carried out by means of a simple optical encoding.

According to an embodiment, the measurement of the inspection parameters related to the position of said probe in the space is carried out by means of devices including gyroscopes.

This invention also relates to a device for implementing the method mentioned above.

The following are the advantages of the method according to this invention:
It has only one representative structure (potentially in real conditions), except from defects. The defects are introduced in the simulations by the configuration generator (virtual model), and the operator can inspect the structure N times with N virtual defects that are different and/or positioned in different places of the structure;
It provides signals from the real information returned (ex. ultrasonic coupling problem);
It varies the parameters on demand related to:
   i) the defects: position, geometry
   ii) the structure itself: variable thickness on the opposite side, presence of stiffeners, abnormal presence of a steel fitting among a line of titanium fittings, etc.
   iii) the inspection: disruption in the parameter values for an operator response test.

### BRIEF DESCRIPTION OF THE DRAWINGS

The invention will be better understood with the help of the description, contained herein purely for the purpose of explanation, and an embodiment of the invention, with reference to the figures, in which:

FIG. 1a illustrates an example of Probability of Detection (POD) data, and

FIG. 1b shows a POD curve;

FIG. 2 is a block diagram of the method according to this invention; and

FIG. 3 illustrates some examples of synthetic signals.

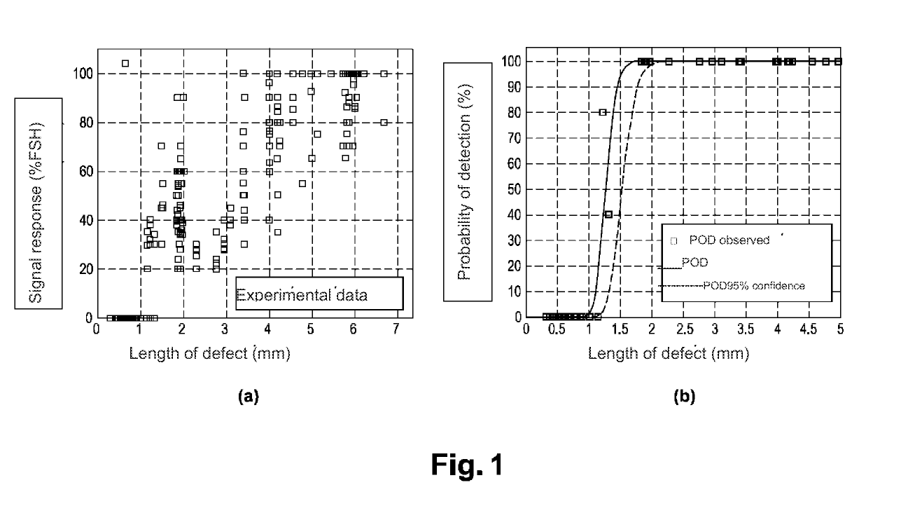

### DETAILED DESCRIPTION OF THE EMBODIMENTS OF THE INVENTION

As part of this invention, a solution is proposed, this solution being to create a non-destructive testing (NDT) simulator in which the operators really carry out the inspection, but interpret synthetic signals.

The signals carried out on the screen of a piece of testing equipment (with a PC) are called synthetic insofar as they are not (exactly) the signals recorded by the acquisition card of the instrument used.

These signals, for example, may be:
measured signals;
measured and modified signals (ex. weighting, time-based amplification, transfer function, etc.);
simulated and/or modeled signals;
a combination of measured (and possibly modified) signals and simulated/modeled signals.

These signals should be as realistic as possible and correspond to signals that can be measured on the structure areas concerned, taking into account the following information:
the real positioning of the probe in the space; and
settings carried out by the operator (details).

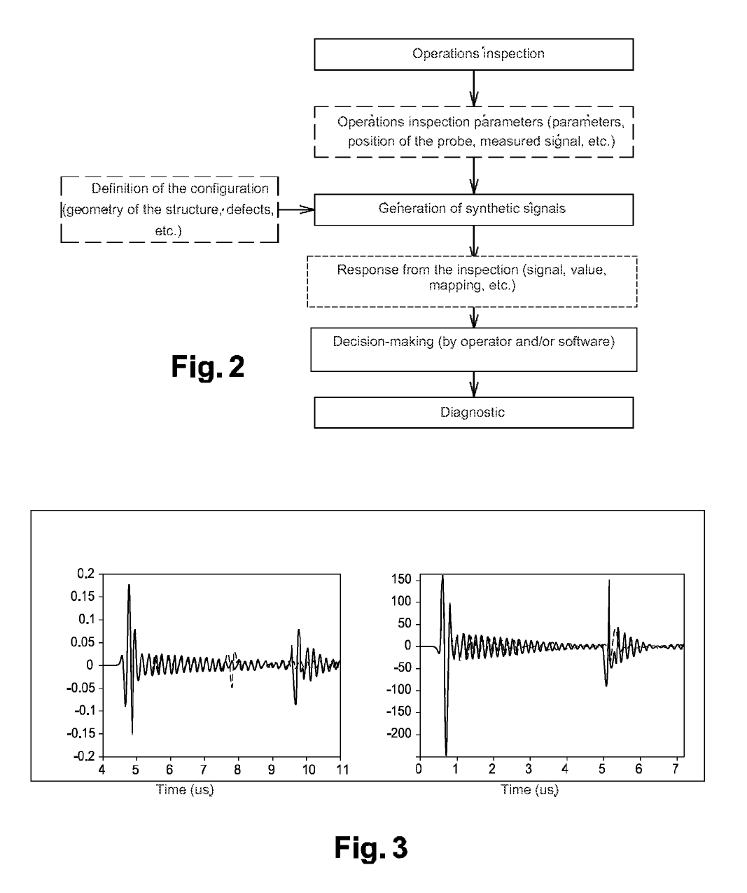

FIG. 2 is a block diagram of the method according to this invention: an operations inspection is carried out. Depending on the parameters related to the operations inspection (settings, position of the probe, measured signal, etc.) and depending on the definition of the geometry of the structure and the current configuration (defect(s) introduced by the configuration generator), synthetic signals are generated. Depending on the inspection response (signal, value, mapping, etc.), a decision is made, either by an operator or even through software, and finally, a diagnostic is made. The synthetic signals generated may be, depending on the testing configurations, either displayed immediately (real time) on the screen of the inspection device or provided to the software in charge of acquiring data, to be processed at a later time for the diagnostic.

The method according to this invention comprises three steps, which are:
the measurement of the inspection parameters related to the position in the space of the probe (or sensor);
the signal synthesis associated with the inspection parameters (including the probe) and defects; and
the establishment of the correspondence between the inspection parameters and the signals through the configuration generator (virtual model and defect(s)).

The generation of the synthetic signals is conditioned by:
the measured inspection parameters;
the configuration generated by the “configuration generator” which consists of a virtual model (DMU) of the structure, this DMU being able to be completed by the introduction of defects and/or by the modification of the properties of the structure elements (thickness of parts, geometry of the reverse side, and material). This element is comparable to the software element that changes the parameters of a section in video games.

A third important element to be implemented from the invention relates to the communication between these three subsystems to ensure a fluid display of synthetic signals on the screen.

The measurement of the “sensor positioning” parameters depends on the complexity of the inspection operation, particularly the probe's number of possible positions:
the probe moves along a plane: two possible positions, so simple encoding is enough (automata with two axes);
the probe moves over an uneven surface but cannot pivot, and its rotation does not influence the measurement: simple optical encoding can be used to determine its position (x, y, z);
the probe moves in the space with many possible positions (x, y, z, Rx, Ry,

Rz): sophisticated devices, including gyroscopes, can be implemented (ex. cameras and optical markers on the probe, etc.).

Other data can be used as input for the synthetic data generation model, such as:
the parameters for the device settings, which can be retrieved directly on the device's acquisition card;
real measured signals (or a portion of them), which can also be retrieved directly on the device's acquisition card;
the structure-defect configuration supplied by the configuration generator.

Another step consists of generating synthetic signals that correspond to the non-destructive testing (NDT) operation that the operation is in the process of carrying out. These signals are displayed in real time (or controlled deferred) on the screen of the inspection device.

Thus, the operator has the impression that the signals displays are those that are actually measured.

The signal synthesis is very useful in musical acoustics, such as for digital instruments. Two such approaches have been developed. In the first, the digital instrument “plays” the prerecorded notes picked from a database so as to generate a realistic acoustic signal, and in the second, the synthesized signals use simulated signals by using physical instrument models.

By the same principle, signals corresponding to the response to a non-destructive testing (NDT) operation can be synthesized. The most analogous example relates to ultrasound inspections that supply acoustic sonogram signals of structures. However, the concept can be extended without restriction to electromagnetic or even radiographic signals.

The synthesized signals can, for example, be generated by using:
previously measured signals recorded in a database;
simulated signals;
a combination of real and simulated signals, particularly using a simulated defect response that is then integrated into a real signal;
signals (real or simulated) that are processed (ex. filtering for porosity); and/or
an interpolation between two signals (real or synthetic) so as to closely reproduce a lack of clarity, such as alongside defects.

FIG. 3 illustrates examples of synthetic signals.

This signal synthesis makes it possible to position “virtual” defects at any location of the structure, and with any possible geometry.

The link between the inspection parameters and the synthetic signal is provided simply by using inspection devices equipped with a PC that can establish a direct link between:
the acquisition card;
the device for measuring the position of the sensor in the space;
the virtual model; and
the signal synthesis module.

Optionally, interactivity between an operator and the measurement device can be implemented, such as to automate the input of the inspection results (detection, amplitude, and sizing). This interactivity can be provided by the graphical user interface (GUI) of the measurement device.

This invention can be used by any manufacturer implementing non-destructive testing (NDT) or even by training and testing centers for NDT operators, for the purpose of:
carrying out estimations of Probability of Detection (POD) curves under realistic conditions and at a low cost;
setting up and improving inspection procedures;
training NDT operators; or even
certifying NDT operators under operating conditions.

The method according to the invention can also be used to evaluate the diagnostic performance of analysis software using the generation of synthetic signals having variable defects (synthetic mapping).

The invention is described above as an example. It is understood that those skilled in the art can create different variants of the invention without straying from the context of the patent.

1-12. (canceled)

13. A method of stimulating non-destructive testing using at least one probe, comprising the steps of:
measuring inspection parameters linked to a position of said probe in the space by a measurement device comprising gyroscopes; and
generating synthetic signals corresponding to an operation of a non-destructive testing of a structure.

14. The method of claim 13, further comprising the step of partially conditioning the synthetic signals by a configuration generated by a configuration generator comprising a virtual model of the structure.

15. The method of claim 14, further comprising the step of introducing defects or modifying properties of structure elements to complete said virtual model of the structure.

16. The method of claim 13, wherein said synthetic signals are measured signals.

17. The method of claim 13, wherein said synthetic signals are measured and modified signals.

18. The method of claim 17, further comprising the step of modifying said signals according to at least one of the following: a weighting, a time-based amplification, or a transfer function.

19. The method of claim 13, further comprising the step of simulating or modeling said synthetic signals.

20. The method of claim 13, further comprising the step of combining measured signals and simulated/modeled signals to provide said synthetic signals.

21. The method of claim 16, further comprising the step of measuring said synthetic signals on concerned areas of the structure considering real positioning information of said probe in the space.

22. The method of claim 16, further comprising the step of measuring said synthetic signals on concerned areas of the structure considering information related to settings carried out by an operator.

23. The method of claim 13, further comprising the step of encoding to measure the inspection parameters linked to the position of said probe in the space.

24. The method of claim 13, further comprising the step of optical encoding to measure the inspection parameters linked to the position of said probe in the space.
